(19) United States
(12) Patent Application Publication
(10) Pub. No.: US 2010/0274867 A1
(43) Pub. Date: Oct. 28, 2010

(54) COMMUNICATION APPARATUS, CONTROL METHOD THEREOF, AND COMMUNICATION SYSTEM

(75) Inventor: Tetsuya Sawada, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/743,580

(22) PCT Filed: Jan. 23, 2009
(86) PCT No.: PCT/JP2009/051518

§ 371 Date: May 19, 2010

(30) Foreign Application Priority Data
Feb. 15, 2008 (JP) 2008-035083

(51) Int. Cl. G06F 15/177; G06F 15/16

(52) U.S. Cl. 709/208; 709/221; 709/249

(57) ABSTRACT

A communication apparatus that uses a base station function and a slave function includes a switching means that switches from operating as the slave station to operating as the base station, and a setting means that sets a character string constituting an identifier of a network to be newly created when operating as the base station, if switching to operating as the base station, and the setting means sets the character string constituting the identifier of the new network, so as to include a character string constituting an identifier of a network participated in when operating as the slave station, in order to improve the usability of network connection.

### TECHNICAL FIELD

The present invention relates to network formation technique.

### BACKGROUND ART

Conventionally, identifiers are assigned to networks to enable the networks to be distinguished, in order to improve usability and connectivity. These identifiers include a service set identifier (SSID) defined in IEEE 802.11.

Since SSIDs can be set arbitrarily, a number of proposals have been made concerning their setting method. For example, Japanese Patent Application Laid-Open No. 2003-101553 discloses a technique for firstly setting a temporary identifier and performing authentication, after which a proper identifier is set. Japanese Patent Application Laid-Open No. 2007-5892 discloses a technique for setting a genre name of information to be distributed as an identifier. Further, Japanese Patent No. 3698711 discloses a technique for setting the application name of an application to be executed as an identifier.

However, if an identifier is changed using the above techniques, the new identifier bears no relation to the previous identifier. Thus, a user has no way of knowing the relation between a network prior to an identifier being changed and a network after the identifier has been changed.

For example, there are wireless LAN terminals that create and manage a new network (basic service set or BSS) after operationally changing from a station (STA) function to an access point (AP) function. Such wireless LAN terminals may, according to preset conditions, also operationally change back to the STA function and rejoin a BSS that they were participating in previously, after discarding the newly created BSS. The problem was that other external terminals may, at this time, mistakenly join the newly created BSS or have difficulty joining the new BSS. Also, other external terminals were faced with the difficulty of determining which other BSS to rejoin, in the case where a new BSS was discarded. In other words, there was a problem with the usability of network connection.

The present invention has been made in consideration of the above problems, and has as its object to improve the usability of network connection.

### DISCLOSURE OF INVENTION

According to one aspect of the present invention, a communication apparatus comprises: communication means for communicating based on a network identifier; setting means for setting the network identifier to communicate by the communication means, wherein the setting means sets a first network identifier related to a second network identifier, if switching to a first network of the first network identifier from a second network of the second network identifier.

According to another aspect of the present invention, a communication apparatus that has a base station function for operating as a base station and a slave function for operating as a slave station which connects to a base station, comprises: switching means for switching from operating as the slave station to operating as the base station; and setting means for setting, if switching to operating as the base station by the switching means, a character string constituting an identifier of a new network, wherein the setting means sets the character string constituting the identifier of the new network, so as to include a character string constituting an identifier of a network participated in when operating as the slave station.

According to still another aspect of the present invention, a communication apparatus having a slave function for connecting to a base station, comprises: setting means for setting a character string constituting an identifier of a network to be connected by the slave function; determination means for determining whether there exists a base station that has created a network whose identifier is constituted by a same character string as the character string constituting the identifier set by the setting means; search means for searching for an identifier of a peripheral network, if determined by the determination means that the base station does not exist; and control means for controlling the setting means to set, as a changed character string, a character string, out of character strings constituting one or more identifiers retrieved by the search means, at least part of which matches the character string constituting the identifier currently set by the setting means.

According to yet another aspect of the present invention, a control method of a communication apparatus comprises: a communication step of communicating based on a network identifier; a setting step of setting the network identifier to communicate at the communication step, wherein the setting step sets a first network identifier related to a second network identifier, if switching to a first network of the first network identifier from a second network of the second network identifier.

According to still yet another aspect of the present invention, a control method of a communication apparatus that has a base station function for operating as a base station and a slave function for operating as a slave station which connects to a base station, comprises: a switching step of switching from operating as the slave station to operating as the base station; and a setting step of setting, if switching to operating as the base station in the switching step, a character string constituting an identifier of a new network, wherein in the setting step, the character string constituting the identifier of the new network is set so as to include a character string constituting an identifier of a network participated in when operating as the slave station.

According to yet still another aspect of the present invention, a control method of a communication apparatus that has a slave function for connecting to a base station, comprises: a setting step of setting a character string constituting an identifier of a network to be connected by the slave function; a determination step of determining whether there exists a base station that has created a network whose identifier is constituted by a same character string as the character string constituting the identifier set in the setting step; a search step of searching for an identifier of a peripheral network, if determined in the determination step that the base station does not exist; and a control step of setting, as a changed character string, a character string, out of character strings constituting one or more identifiers retrieved in the search step, at least part of which matches the character string constituting the identifier currently set in the setting step.

According to the present invention, a technique can be provided that enables the usability of network connection to be improved.

Further features of the present invention will become apparent from the following description of exemplary embodiments (with reference to the attached drawings).

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 shows apparatuses included in a wireless communication system according to a first embodiment.

FIG. 2 shows the internal functional configurations of an AP 101, a PC 111, an IJP 121 and a DVC 131.

FIG. 3 illustratively shows a wireless network configuration in an initial state in the wireless communication system according to the first embodiment.

FIG. 4 shows a setting format of the character string for an SSID to be used by a new BSS in the wireless communication system according to the first embodiment.

FIG. 5 is a flowchart showing an operation example 1 of the wireless communication system.

FIG. 6 shows a wireless network configuration after SSID setting as a result of the operation example 1.

FIG. 7 is a flowchart showing an operation example 2 of the wireless communication system.

FIG. 8 shows a wireless network configuration after SSID setting as a result of the operation example 2.

FIG. 9 is a flowchart for displaying a network configuration of the wireless communication system.

FIG. 10 illustratively shows a display screen of a network configuration displayed on a display unit.

FIG. 11 is a flowchart showing an operation example 3 of the wireless communication system.

FIG. 12 shows a wireless network configuration after SSID setting as a result of the operation example 3.

FIG. 13 illustratively shows a wireless network configuration in an initial state in a wireless communication system according to a second embodiment.

FIGS. 14A and 14B illustrate a setting format of the character string of an SSID to be used by a new BSS in the wireless communication system according to the second embodiment.

FIG. 15 is a flowchart showing an operation example of the wireless communication system.

FIG. 16 is a flowchart showing a following operation example of the wireless communication system.

FIG. 17 shows a wireless network configuration after SSID setting.

FIG. 18 illustratively shows a wireless network configuration in an initial state in a wireless communication system according to a third embodiment.

FIGS. 19A and 19B illustrate a setting format of the character string of an SSID to be used by a new BSS in the wireless communication system according to the third embodiment.

FIG. 20 is a flowchart showing an operation example of the wireless communication system.

FIG. 21 is a flowchart showing a following operation example of the wireless communication system.

FIG. 22 shows a wireless network configuration after SSID setting.

FIG. 23 illustratively shows a wireless network configuration in an initial state in a wireless communication system according to a fourth embodiment.

FIG. 24 shows a setting format of the character string of an SSID to be used by a new BSS in the wireless communication system according to the fourth embodiment.

FIG. 25 is a flowchart showing an operation example of the wireless communication system.

FIG. 26 shows a wireless network configuration after SSID setting.

### BEST MODE FOR CARRYING OUT THE INVENTION

Hereinafter, preferred embodiments of the present invention will be described in detail with reference to the drawings. Note that the following embodiments are merely illustrative, and are not intended to limit the scope of the present invention. Note also that the following embodiments will be described using the wireless communication standard IEEE 802.11. However, other standards can also be applied provided that the communication method involves forming a network between devices with matching preset network identifiers.

### First Embodiment

<System Configuration>

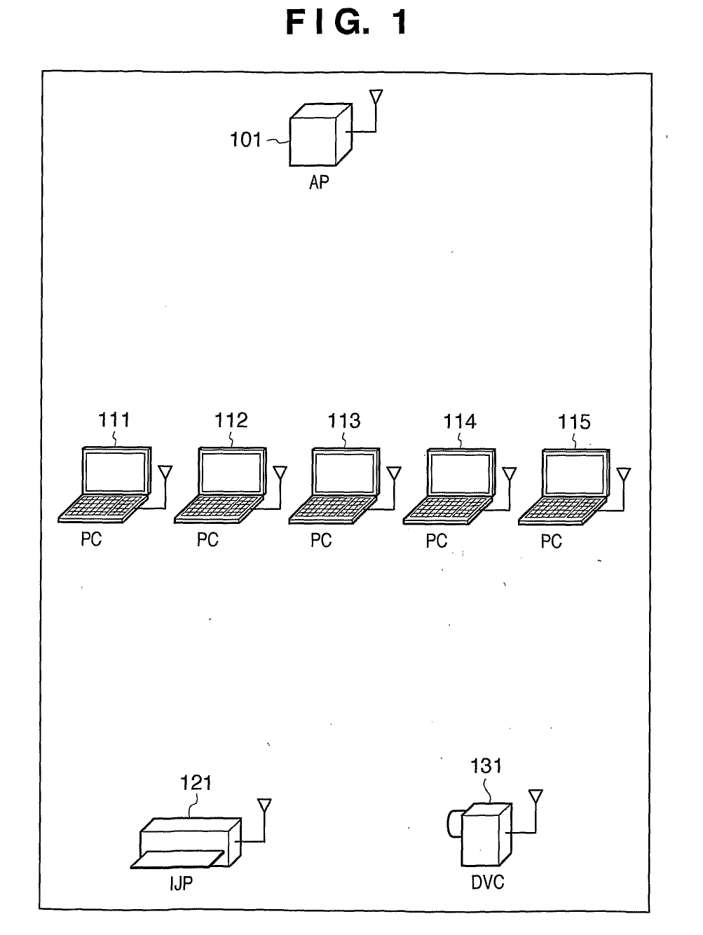

FIG. 1 shows apparatuses included in a wireless communication system according to a first embodiment.

Reference numeral 101 denotes an access point that serves as an access point apparatus (AP) compatible with IEEE 802.11. The AP 101 functions as a base station. Reference numerals 111 to 115 denote personal computers (PCs) that serve as station apparatuses (STAs) compatible with IEEE 802.11. The STAs function as slave stations. Reference numeral 121 denotes an inkjet printer (IJP) that serves as an STA or an AP compatible with IEEE 802.11. Reference numeral 131 denotes a digital video camera (DVC) that serves as an STA or an AP compatible with IEEE 802.11.

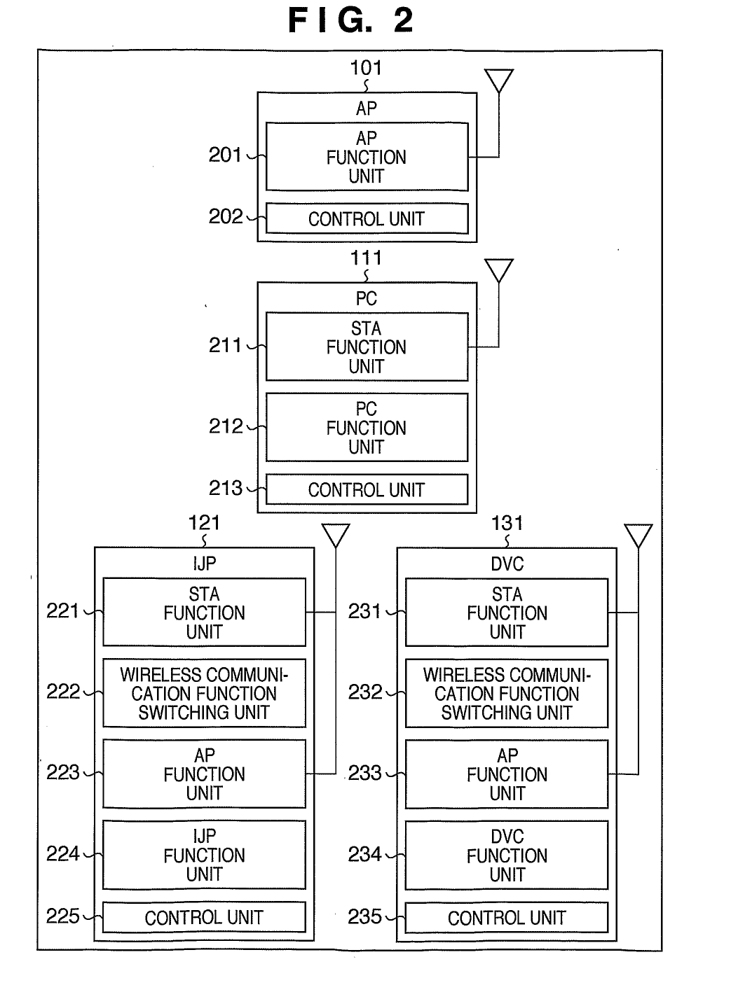

FIG. 2 shows the internal functional configurations of the AP 101, the PC 111, the IJP 121 and the DVC 131. Note that hereinafter a function for receiving a connection from an external wireless communication device will be called an access point (AP) function, and a function for connecting to an external wireless communication device that executes the AP function will be called a station (STA) function. Note also that the AP function and the STA function are used selectively.

Reference numeral 101 denotes a functional configuration of an access point apparatus (AP). Reference numeral 201 denotes an AP function unit that provides the AP function, and is constituted by a wireless module, a driver and the like. Apparatuses (e.g., PCs 111 to 115, IJP 121, DVC 131) provided with the STA function are able to communicate with one another via the AP 101, as a result controlling a basic service set (BSS) in infrastructure mode using the AP function unit 201. Reference numeral 202 denotes a control unit that performs integrated control of the constituent elements in the AP 101.

Reference numeral 111 denotes a functional configuration of a personal computer (PC). Note that the functional configurations of the PCs 112 to 115 are similar. Reference numeral 211 denotes an STA function unit that provides the STA function and is constituted by a wireless module, a driver and the like. The PC 111, using the STA function unit 211, performs wireless communication, via the AP 101, with apparatuses provided with the STA function such as the PCs 112 to 115, the IJP 121 and the DVC 131, within the BSS in infrastructure mode controlled by the AP 101, for example. Note that a configuration in which the PC 111 is provided with an STA function in ad hoc mode is possible, as will be discussed below. In this case, the PC 111 is able to itself create a BSS (also called an independent BSS or IBSS). Reference numeral 212 denotes a PC function unit that provides a PC function, and is constituted by a central processing unit (CPU), a memory, a hard disk, a keyboard, a liquid crystal display (LCD), an operating system (OS) and applications. The PC function unit 212 provides a known PC function, a detailed description of which will be omitted. Reference numeral 213 denotes a control unit that performs integrated control of the constituent elements in the PC 111.

Reference numeral 121 denotes a functional configuration of an inkjet printer (IJP). Reference numeral 221 denotes an STA function unit. The STA function unit 221 is similar to the STA function unit 211 of the PC 111. Reference numeral 222 denotes a wireless communication function switching unit which is constituted by a driver and the like. The wireless communication function switching unit 222 switches between the operation of the STA function unit 221 and an AP function unit 223. Reference numeral 223 denotes an AP function unit. The AP function unit 223 is similar to the AP function unit 201 of the AP 101. Reference numeral 224 denotes an IJP function unit which is constituted by a paper feeding mechanism, an ink tank, a print head and the like. The IJP function unit 224 provides a known IJP function, a detailed description of which will be omitted. Reference numeral 225 denotes a control unit that performs integrated control of the constituent elements in the IJP 121.

Reference numeral 131 denotes a functional configuration of a digital video camera (DVC). Reference numeral 231 denotes an STA function unit. The STA function unit 231 is similar to the STA function unit 211 of the PC 111. Reference numeral 232 denotes a wireless communication function switching unit. The wireless communication function switching unit 232 is similar to the wireless communication function switching unit 222 of the IJP 121. Reference numeral 233 denotes an AP function unit. The AP function unit 233 is similar to the AP function unit 201 of the AP 101. Reference numeral 234 denotes a DVC function unit which is constituted by a lens, an imaging element such as a charge-coupled device (CCD), video recording tape, and the like. The DVC function unit 234 provides a known DVC function, a detailed description of which will be omitted. Reference numeral 235 denotes a control unit that performs integrated control of the constituent elements in the DVC 131.

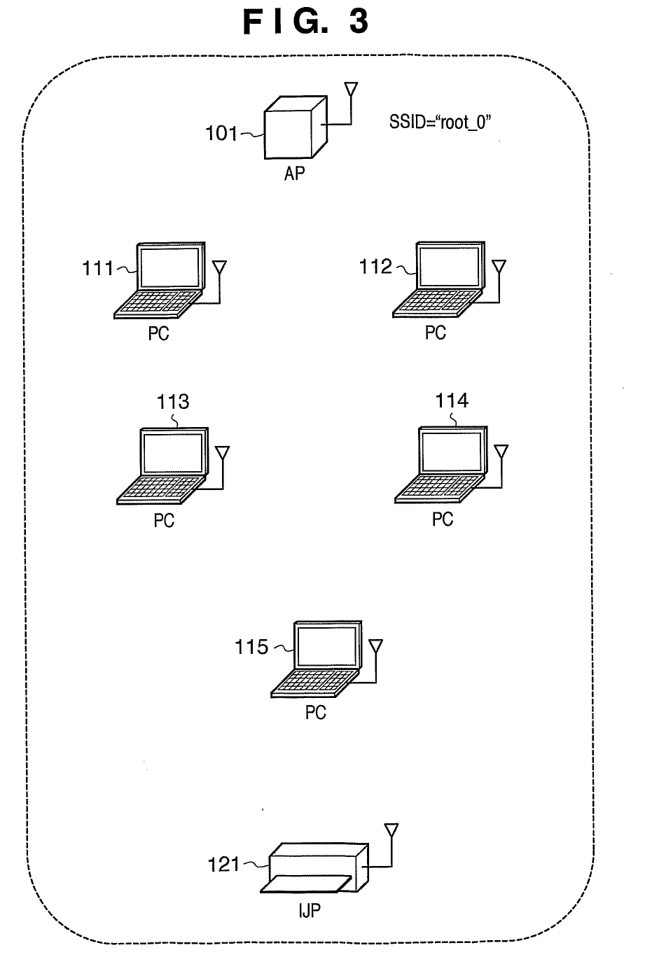

FIG. 3 illustratively shows a wireless network configuration in an initial state in the wireless communication system according to the first embodiment.

The AP 101 controls a BSS in which “root_{—}0” is set in the AP function unit 201 as the character string of the SSID. On the other hand, the PCs 111 to 115 and the IJP 121 perform wireless communication within the BSS “root_{—}0” controlled by the AP 101, having set the same character string “root_{—}0” as the AP 101 in their respective STA function unit 211 or 221 as the character string of the SSID.

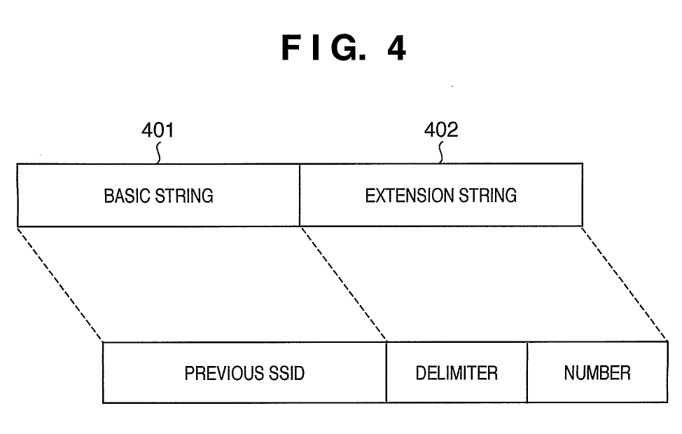

FIG. 4 shows a setting format of the character string of an SSID to be used by a new BSS in the wireless communication system according to the first embodiment.

Reference numeral 401 denotes a basic string. The basic string 401 is set to the character string of the SSID previously used, which is the character string used in the initial state, for example. Reference numeral 402 denotes an extension string. The extension string 402 is set to a character string that combines the delimiter (partition character) “_” and a number. In other words, a character string that combines the SSID previously used, “_” and a number is set as the character string of the SSID to be used by the new BSS. Note that an index number (identification string) for distinguishing from another network in the same branching hierarchy (discussed below) may be used as the number.

### Operation Example 1 of Wireless Communication System

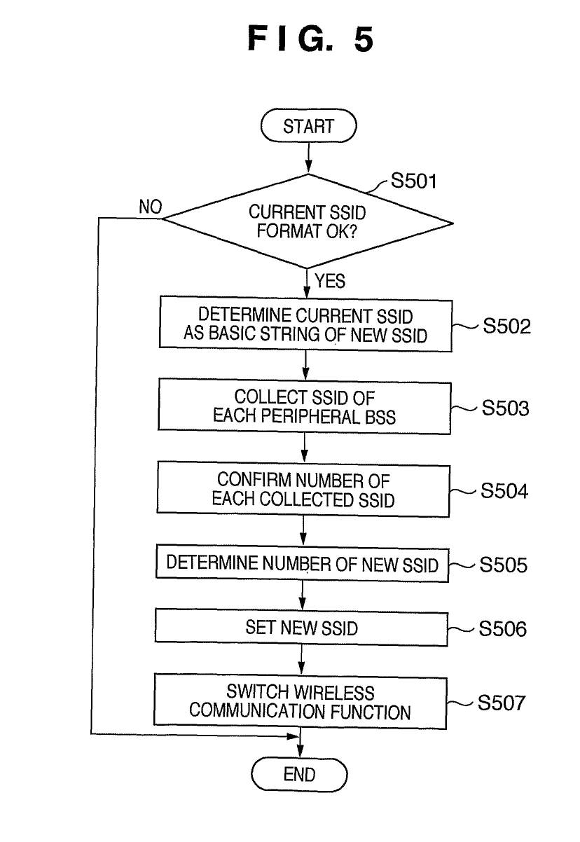

FIG. 5 is a flowchart showing an operation example 1 of the wireless communication system. Here, it is assumed that the IJP 121 creates a new network when some sort of trigger occurs. In other words, when the SSID is reset and the AP function is enabled. A number of triggers are conceivable, such as the IJP 121 becoming ready to print, for example. The following steps of the flowchart are executed by the control unit 225 of the IJP 121.

At step S501, the control unit 225 determines whether the character string format of the SSID currently set in the STA function unit 221 matches the format shown in FIG. 4. If matched, the processing proceeds to step S502, and if not matched, the processing ends. For example, the control unit 225 confirms the format of “root_{—}0” and determines that the format matches.

At step S502, the control unit 225 sets the basic string 401 of the SSID to be newly set in the AP function unit 223 to the character string of the SSID confirmed at step S501. Here, “root_{—}0” is set as the basic string 401.

At step S503, the control unit 225 controls the STA function unit 221 to search for and collect the SSIDs used by BSSs in the vicinity of the IJP 121.

At step S504, the control unit 225 confirms the extension string 402 of any collected SSIDs that include the character string determined at step S502. Specifically, the control unit 225 confirms the “number” portion included in the extension string 402.

At step S505, the control unit 225 sets the number of the extension string 402 of the SSID to be newly set in the AP function unit 223 to a number other than any of the numbers confirmed at step S504. That is, the control unit 225 decides on a number not used by a peripheral BSS. For example, if another BSS does not exist in the vicinity, “0” is set as the number. On the other hand, if “root_{—}0_{—}0” and “root_{—}0_{—}1” are already being used as SSIDs by peripheral BSSs, “2” is determined as the extension string.

At step S506, the control unit 225 determines a character string obtained by adding a character string composed of a combination of the delimiter “_” and the number set at step S505 to the basic string 401 determined at step S502 as the SSID to be newly set, and sets this character string in the AP function unit 223.

At step S507, the control unit 225 controls the wireless communication function switching unit 222 to switch the wireless function from the STA function unit 221 to the AP function unit 223.

The IJP 121 creates a new BSS as a result of the above steps.

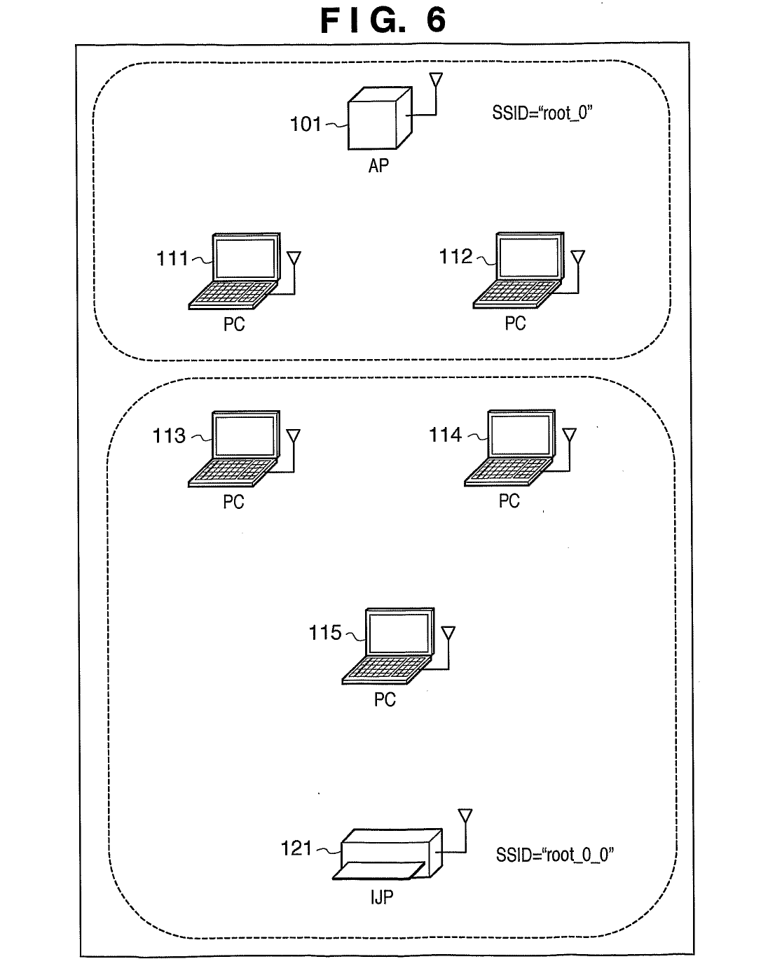

FIG. 6 shows a wireless network configuration after SSID setting as a result of the operation example 1. Here, an example is shown in which the IJP 121 has created a BSS in which “root_{—}0_{—}0” is set as the SSID, and then the PCs 113 to 115 have subsequently changed their SSIDs and moved to the BSS controlled by the IJP 121, after confirming that the IJP 121 whose SSID is set to “root_{—}0_{—}0” exists by scanning. In other words, the above SSID determination procedure enables a user to know from the SSID character string that a BSS “root_{—}0_{—}0” derived from the BSS “root_{—}0” has been newly created.

In this state, the AP 101 controls the BSS “root_{—}0”, having set the SSID to “root_{—}0” in the AP function unit 201. The PCs 111 and 112 perform wireless communication within the BSS “root_{—}0” controlled by the AP 101, having set the SSID to “root_{—}0” in their respective STA function unit 211. On the other hand, the IJP 121 controls the BSS “root_{—}0_{—}0”, having set the SSID to “root_{—}0_{—}0” in the AP function unit 223. The PCs 113 to 115 perform wireless communication within the BSS “root_{—}0_{—}0” controlled by the IJP 121, having set the SSID to “root_{—}0_{—}0” in their respective STA function unit 211.

The PCs 113 to 115 are thereby easily able to confirm BSSs created in the vicinity that are related. Thus, the usability of network connection can be improved.

### Operation Example 2 of Wireless Communication System

Following on from the above operation example 1, an example will now be described in which the PC 113 newly creates a BSS (IBSS). The initial state in this case is the state shown in FIG. 6.

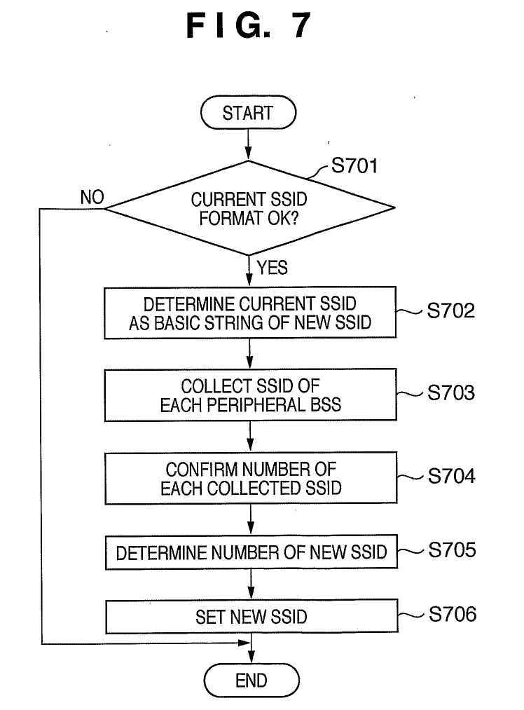

FIG. 7 is a flowchart showing an operation example 2 of the wireless communication system. Here, it is assumed that the PC 113 creates a new network when some sort of trigger occurs. A number of triggers are conceivable, such as the PC 113 being triggered by detecting bandwidth shortage in the current BSS, for example. The following steps of the flowchart are executed by the control unit 213 of the PC 113.

At step S701, the control unit 213 determines whether the character string format of the SSID currently set in the STA function unit 211 matches the format shown in FIG. 4. If matched, the processing proceeds to step S702, and if not matched, the processing ends. For example, the control unit 213 confirms the format of “root_{—}0_{—}0” and determines that the format matches.

At step S702, the control unit 213 sets the basic string 401 of the SSID to be newly set in the STA function unit 211 to the character string of the SSID confirmed at step S701. Here, “root_{—}0_{—}0” is set as the basic string 401.

At step S703, the control unit 213 controls the STA function unit 211 to scan for and collect the SSIDs used by BSSs in the vicinity of the PC 113.

At step S704, the control unit 213 confirms the extension string 402 of any collected SSIDs that include the character string determined at step S702. Specifically, the control unit 213 confirms the number portion included in the extension string 402.

At step S705, the control unit 213 sets the number of the extension string 402 of the SSID to be newly set in the STA function unit 211 to a number other than any of the numbers confirmed at step S704. That is, the control unit 213 decides on a number not used by a peripheral BSS. For example, if another BSS does not exist in the vicinity, “0” is set as the number. On the other hand, if “root_{—}0_{—}0_{—}0” and “root_{—}0_{—}0_{—}1” are already being used as SSIDs by peripheral BSSs, “2” is determined as the extension string.

At step S706, the control unit 213 determines a character string composed of a combination of the basic string 401 determined at step S702, the delimiter “_” and the number set at step S705 as the SSID to be newly set, and sets this character string in the STA function unit 211. The control unit 213 then switches to ad hoc mode.

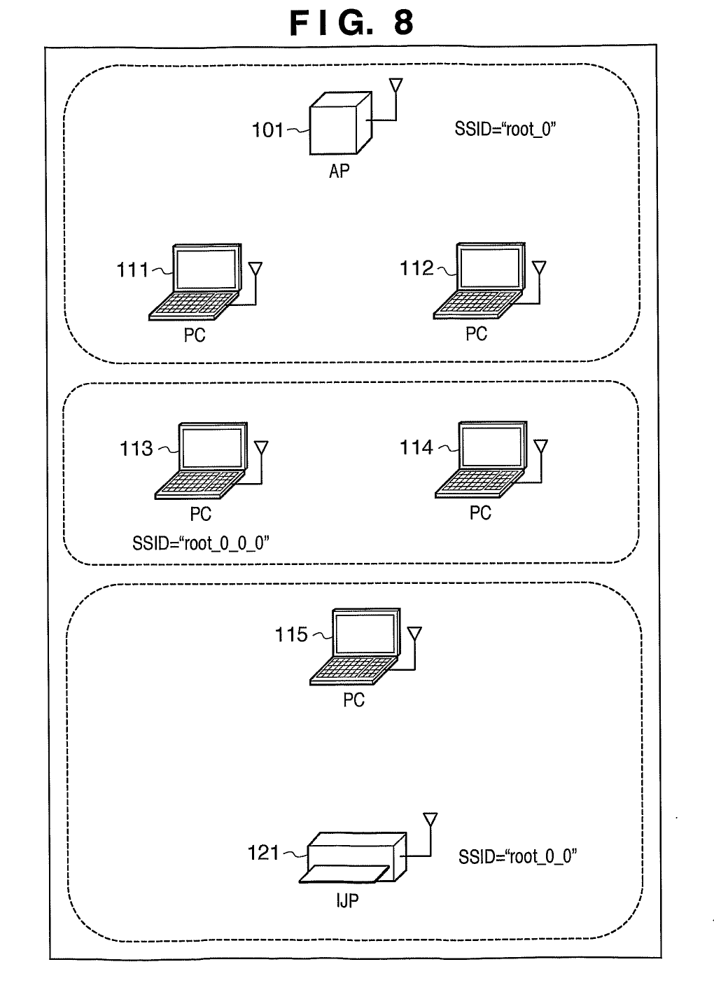

FIG. 8 shows a wireless network configuration after SSID setting as a result of the operation example 2. Here, an example is shown in which the PC 113 has created a BSS (IBSS) in which “root_{—}0_{—}0_{—}0” is set as the SSID, and then the PC 114 has subsequently changed its SSID and moved to the BSS controlled by the PC 113, after confirming that the PC 113 whose SSID is set to “root_{—}0_{—}0_{—}0” exists by scanning. In other words, the above SSID determination procedure enables a user to know from the SSID character string that a BSS “root_{—}0_{—}0_{—}0” derived from the BSS “root_{—}0_{—}0” has been newly created.

In this state, the AP 101 controls the BSS “root_{—}0”, having set the SSID to “root_{—}0” in the AP function unit 201. The PCs 111 and 112 perform wireless communication within the BSS “root_{—}0” controlled by the AP 101, having set the SSID to “root_{—}0” in their respective STA function unit 211. The IJP 121 controls the BSS “root_{—}0_{—}0”, having set the SSID to “root_{—}0_{—}0” in the AP function unit 223. The PC 115 performs wireless communication within the BSS “root_{—}0_{—}0” controlled by the IJP 121, having set the SSID to “root_{—}0_{—}0” in the STA function unit 211. Further, the PC 113 controls the BSS “root_{—}0_{—}0_{—}0”, having set the SSID to “root_{—}0_{—}0_{—}0” in the STA function unit 211. The PC 114 performs wireless communication within the BSS “root_{—}0_{—}0_{—}0” controlled by the PC 113, having set the SSID to “root_{—}0_{—}0_{—}0” in the STA function unit 211.

The PC 114 is thereby able to easily confirm BSSs created in the vicinity that are related. Thus, the usability of network connection can be improved.

<Network Configuration Display in Wireless Communication System>

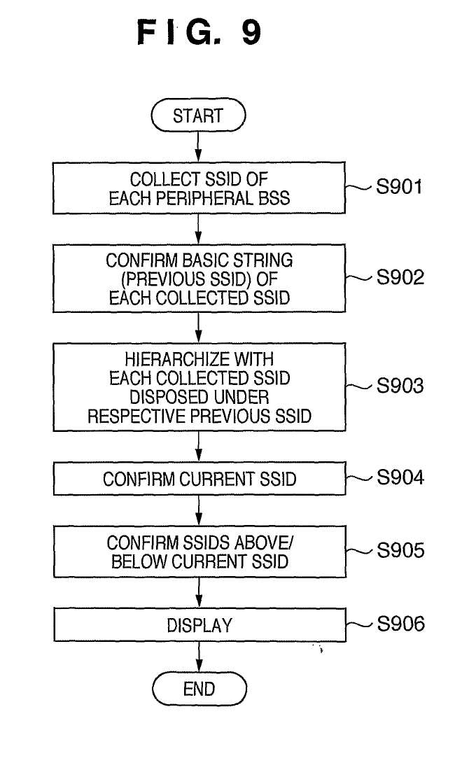

FIG. 9 is a flowchart for displaying a network configuration of the wireless communication system. This process is, for example, executed by an apparatus such as one of the PCs 111 to 115, for example, provided with a display function such as an LCD when some sort of trigger occurs. A number of triggers are conceivable, such as the PC 114 being triggered by receiving an instruction to perform a scan from a user, for example. The following steps of the flowchart are executed by the control unit 213 of the PC 114.

At step S901, the control unit 213 scans for and collects the SSIDs of BSSs created in the vicinity of the PC 114.

At step S902, the control unit 213 confirms the basic string 401 of the SSIDs collected at step S901.

At step S903, the control unit 213 groups any SSIDs collected at step S901 that include the same basic string 401. Further, the SSIDs may be hierarchized based on the number of delimiters included in the character strings thereof. For example, if the SSIDs “root_{—}0”, “root_{—}0_{—}0” and “root_{—}0_{—}0_{—}0” are collected, these SSIDs may be hierarchized so that “root_{—}0_{—}0_{—}0” is disposed below “root_{—}0_{—}0” and “root_{—}0_{—}0” is disposed below “root_{—}0”.

At step S904, the control unit 213 confirms the SSID currently used by the PC 114.

At step S905, the control unit 213 confirms the SSIDs disposed above and below the SSID confirmed at step S904.

At step S906, the control unit 213 generates a display screen and displays the generated display screen on a display unit (not shown).

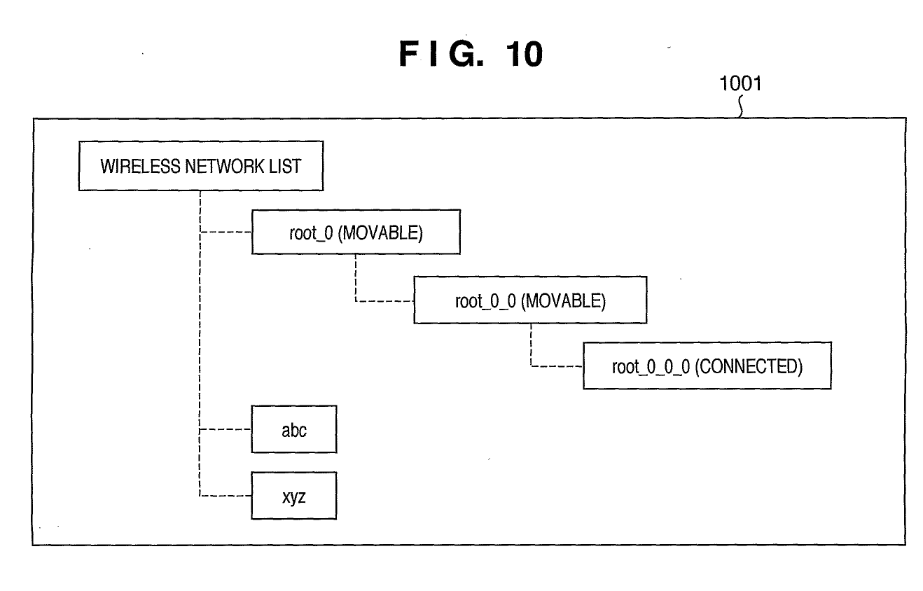

FIG. 10 illustratively shows a display screen of a network configuration displayed on a display unit. Here, a display screen of the wireless network configuration shown in FIG. 8 after the PC 114 has performed a display process is shown. Further, the case where the BSSs “abc” and “xyz” not shown in FIG. 8 exist in the vicinity is illustratively shown on the display screen.

With the display screen 1001, the BSSs “root_{—}0”, “root_{—}0_{—}0”, “root_{—}0_{—}0_{—}0”, “abc” and “xyz” are displayed as a wireless network list. The BSS “root_{—}0_{—}0_{—}0” is displayed below the BSS “root_{—}0_{—}0”, and the BSS “root_{—}0_{—}0” is displayed below the BSS “root_{—}0”. In other words, the BSSs are hierarchically listed based on similarity.

A configuration in which BSSs in the same tree are displayed together with information relating to movement is also possible. For example, “connected” may be displayed in an area corresponding to “root_{—}0_{—}0_{—}0” as the current BSS of the PC 114. Further, “movable” may be displayed in areas corresponding to the superior BSSs “root_{—}0_{—}0” and “root_{—}0” which are in the same group (same tree). In other words, the BSSs “root_{—}0_{—}0” and “root_{—}0_{—}0_{—}0” are derived from the BSS “root_{—}0”, and are movable without changing any parameters (encryption key, encryption method settings, etc.) apart from the SSID. A display such as this enables a user to selectively designate a BSS to be moved to. Thus, it is preferable to additionally provide a reception unit that receives a selection designation from a user.

### Operation Example 3 of Wireless Communication System

Following on from the above operation example 2, an operation will now be described in the case where the PC 113 is powered off and a BSS is discarded. The initial state in this case is the state shown in FIG. 8.

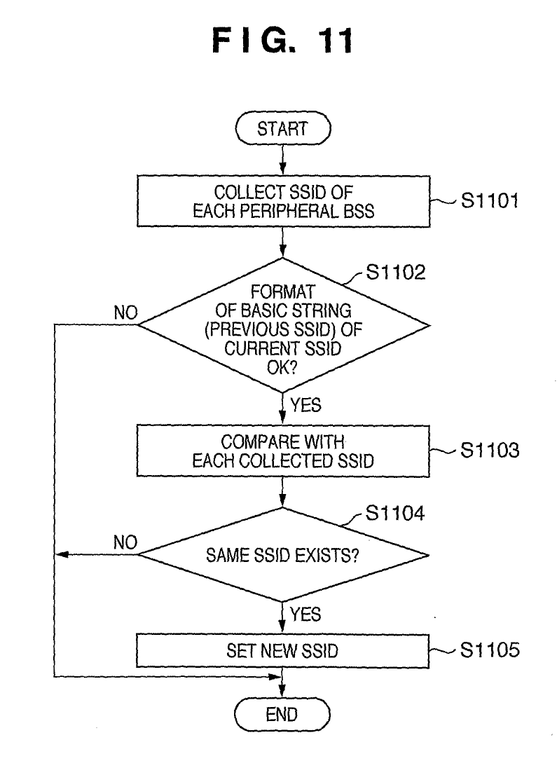

FIG. 11 is a flowchart showing an operation example 3 of the wireless communication system. Here, it is assumed that the PC 114 creates a new network if some sort of trigger occurs. Here, the PC 114 is triggered by detecting the above noted discarding of a BSS due to the PC 113 being powered off. The following steps of the flowchart are executed by the control unit 213 of the PC 114.

At step S1101, the control unit 213 controls the STA function unit 211 to scan for and collect the SSIDs used by BSSs in the vicinity of the PC 114.

At step S1102, the control unit 213 confirms the format of the basic string 401 of the SSID currently set in the STA function unit 211, and determines whether the format matches the format shown in FIG. 4. If matched, the processing proceeds to step S1103, and if not matched, the processing ends. For example, the control unit 213 confirms the format of “root_{—}0_{—}0” and determines that the format matches.

At step S1103, the control unit 213 compares the current SSID with the SSIDs collected at step S1101. The comparison is executed for each SSID collected at step S1101. Note that a configuration in which the control unit 213 further confirms the superior character string “root_{—}0” is possible.

At step S1104, the control unit 213 confirms, as a result of the comparison at step S1103, whether there exists an SSID with the same character string as the basic string 401 of the current SSID. For example, the control unit 213 confirms whether there exists the same SSID as “root_{—}0_{—}0”. If the same SSID exists, the processing proceeds to step S1105, and if the same SSID does not exist, the processing ends.

At step S1105, the control unit 213 sets the basic string 401 of the current SSID as the character string of the new SSID.

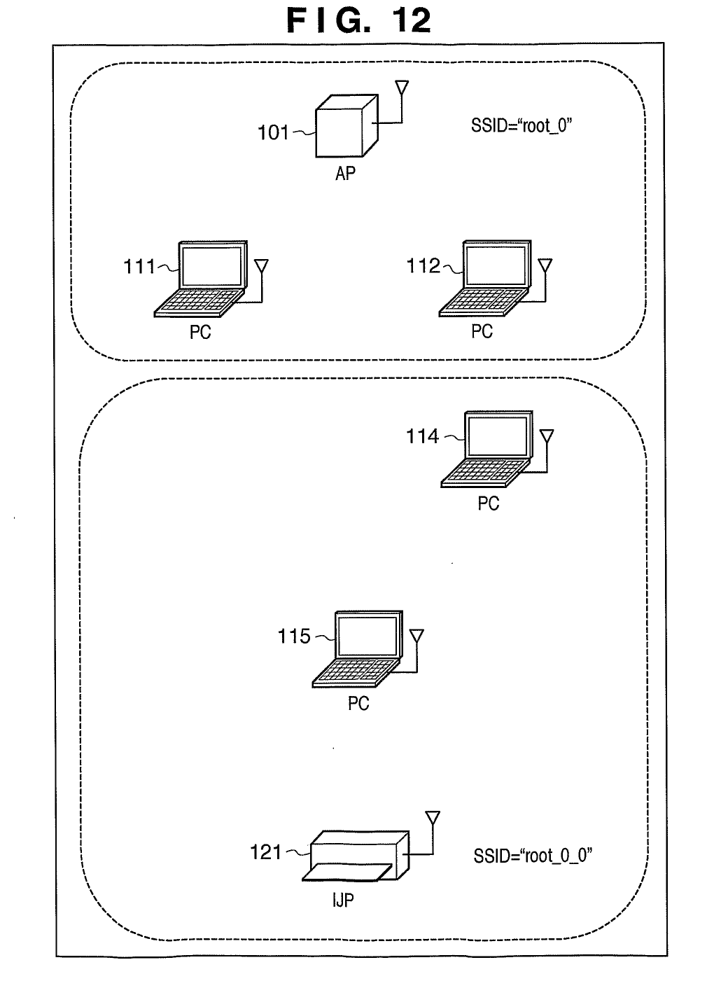

FIG. 12 shows a wireless network configuration after SSID setting as a result of the operation example 3. An example is shown in which the BSS “root_{—}0_{—}0_{—}0” controlled by the PC 113 has thus disappeared from the wireless network configuration of FIG. 8, and then the PC 114 has subsequently changed its SSID and moved to the BSS controlled by the IJP 121.

In this state, the AP 101 controls the BSS “root_{—}0”, having set the SSID to “root_{—}0” in the AP function unit 201. The PCs 111 and 112 perform wireless communication within the BSS “root_{—}0” controlled by the AP 101, having set the SSID to “root_{—}0” in their respective STA function unit 211. The IJP 121 controls the BSS “root_{—}0_{—}0”, having set the SSID to “root_{—}0_{—}0” in the AP function unit 223. The PCs 114 and 115 perform wireless communication within the BSS “root_{—}0_{—}0” controlled by the IJP 121, having set the SSID to “root_{—}0_{—}0” in their respective STA function unit 211.

The PC 114 is thereby able to easily confirm BSSs that are related. Thus, the usability of network connection can be improved.

As described above, a character string that includes a common basic string is used as an SSID, according to the wireless communication system of the first embodiment. Network connectivity can thereby be easily maintained even if a BSS is newly created or discarded. In other words, the usability of network connection can be improved.

Note that an arbitrary character string may be set as an SSID provided that the BSS of a reset SSID is related to the BSS from which the reset SSID is derived, and that the relation between the BSSs is readily evident.

### Second Embodiment

In a second embodiment, a method for setting the character string of an SSID based on a primary application to be used by a newly created network will be described.

<System Configuration>

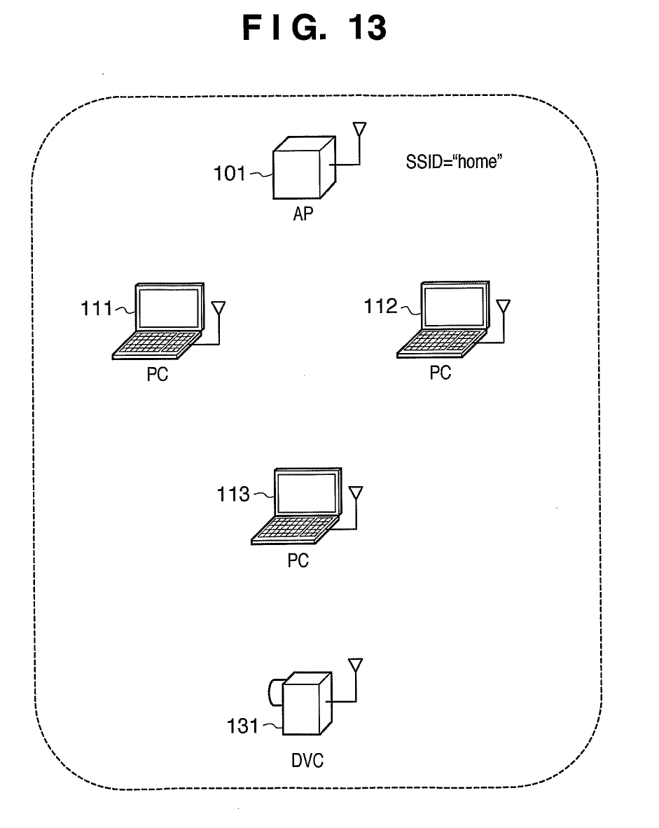

FIG. 13 illustratively shows a wireless network configuration in an initial state in a wireless communication system according to the second embodiment. Note that since the internal configurations of the various apparatuses are similar to the first embodiment, description thereof will be omitted.

The AP 101 controls a BSS in which “home” is set in the AP function unit 201 as the character string of the SSID. On the other hand, the PCs 111 to 113 and the DVC 131 perform wireless communication in the BSS “home” controlled by the AP 101, having set the same character string “home” as the AP 101 in their respective STA function unit 211 or 231 as the character string of the SSID.

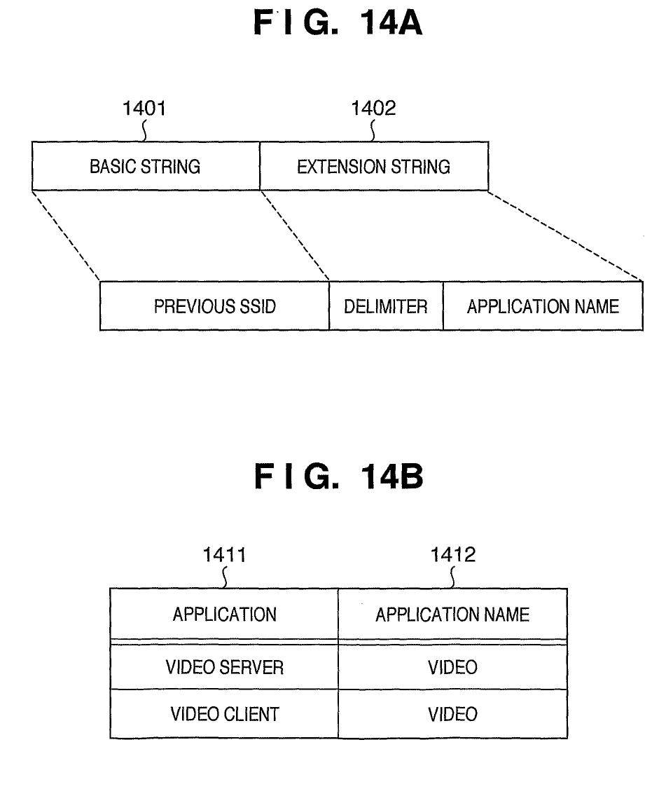

FIGS. 14A and 14B illustrate a setting format of the character string of the SSID to be used by a new BSS in the wireless communication system according to the second embodiment.

In FIG. 14A, reference numeral 1401 denotes a basic string. The basic string 1401 is set to the character string of the SSID previously used, which is the character string used in the initial state, for example. Reference numeral 1402 denotes an extension string. The extension string 1402 is set to a character string that combines the delimiter “_” and an application name. In other words, a character string that combines the SSID previously used, “_” and an application name (information string) is set as the character string of the SSID to be used by the new BSS.

FIG. 14B shows a setting table for designating an application name. Reference numeral 1411 denotes an application, with a video server and a video client being registered. Reference numeral 1412 denotes an application name corresponding to an application, with “VIDEO” being registered here.

### Operation Example of Wireless Communication System

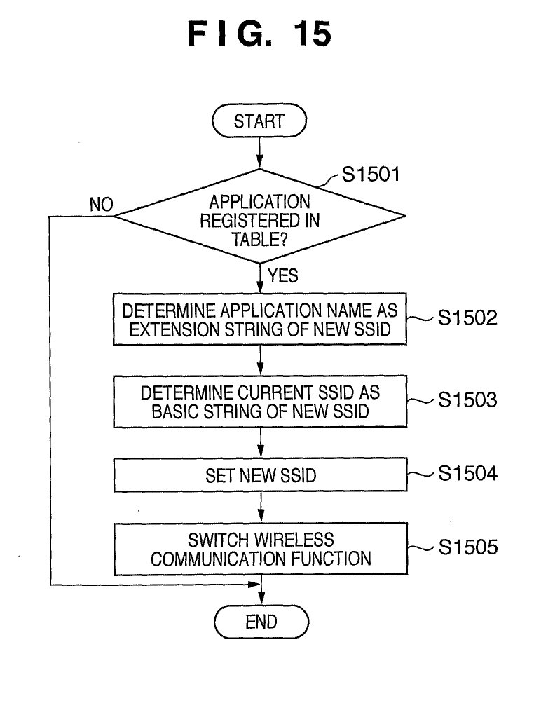

FIG. 15 is a flowchart showing an operation example of the wireless communication system. Here, it is assumed that a new network is created if the video server application is run by the DVC 131. The following steps of the flowchart are executed by the control unit 235 of the DVC 131.

At step S1501, the control unit 235 determines whether the application run by the DVC 131 is registered in the setting table shown in FIG. 14B. If registered, the processing proceeds to step S1502, and if not registered, the processing ends. For example, the control unit 235 determines whether “Video Server” is registered.

At step S1502, the control unit 235 sets the extension string 1402 of the SSID to be newly set in the AP function unit 233 to the application name corresponding to the application run by the DVC 131. Here, the delimiter “_” and “VIDEO” are set as the extension string 1402.

At step S1503, the control unit 235 determines the character string of the SSID currently set in the STA function unit 231 as the basic string 1401 of the SSID to be newly set.

At step S1504, the control unit 235 determines a character string composed of a combination of the basic string 1401 determined at step S1502, the delimiter “_” and the application name set at step S1502 as the SSID to be newly set and sets this character string in the AP function unit 233.

At step S1505, the control unit 235 controls the wireless communication function switching unit 232 to switch the wireless function from the STA function unit 231 to the AP function unit 233.

The DVC 131 creates a new BSS as a result of the above steps. Following on, an example in which the PC 113 sets the SSID will now be described.

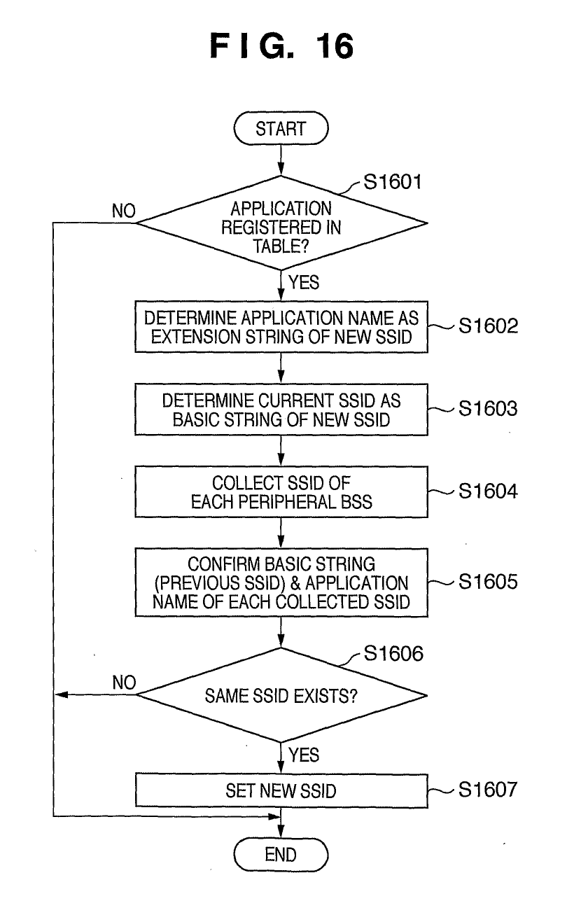

FIG. 16 is a flowchart showing a following operation example of the wireless communication system. Here, it is assumed that the video client application has been run by the PC 113. The following steps of the flowchart are executed by the control unit 213 of the PC 113.

At step S1601, the control unit 213 determines whether the application run by the PC 113 is registered in the setting table shown in FIG. 14B. If registered, the processing proceeds to step S1602, and if not registered, the processing ends. For example, the control unit 213 determines whether “Video Client” is registered.

At step S1602, the control unit 213 sets the extension string 1402 of the SSID to be newly set in the STA function unit 211 to the application name corresponding to the application run by the PC 113. Here, the delimiter “_” and “VIDEO” are set as the extension string 1402.

At step S1603, the control unit 213 determines the character string of the SSID currently set in the STA function unit 211 of the PC 113 as the basic string 1401 of the SSID to be newly set.

At step S1604, the control unit 213 scans for and collects the SSIDs of BSSs created in the vicinity of the PC 113.

At step S1605, the control unit 213 confirms the basic string 1401 and the application name in the extension string 1402 of the SSIDs collected at step S1604.

At step S1606, the control unit 213 confirms whether there exists, among the collected SSIDs, an SSID in which the basic string 1401 and the application name in the extension string 1402 are the same as the character string determined at steps S1603 and S1602. For example, if, in the PC 113, the SSID “home” is currently set and the video client application is run, the control unit 213 confirms whether there exists an SSID the same as “home_VIDEO”. If the same SSID does not exist, the processing ends.

At step S1607, the control unit 213 determines the character string confirmed to exist at step S1606 as the character string of the new SSID, and sets this character string in the STA function unit 211.

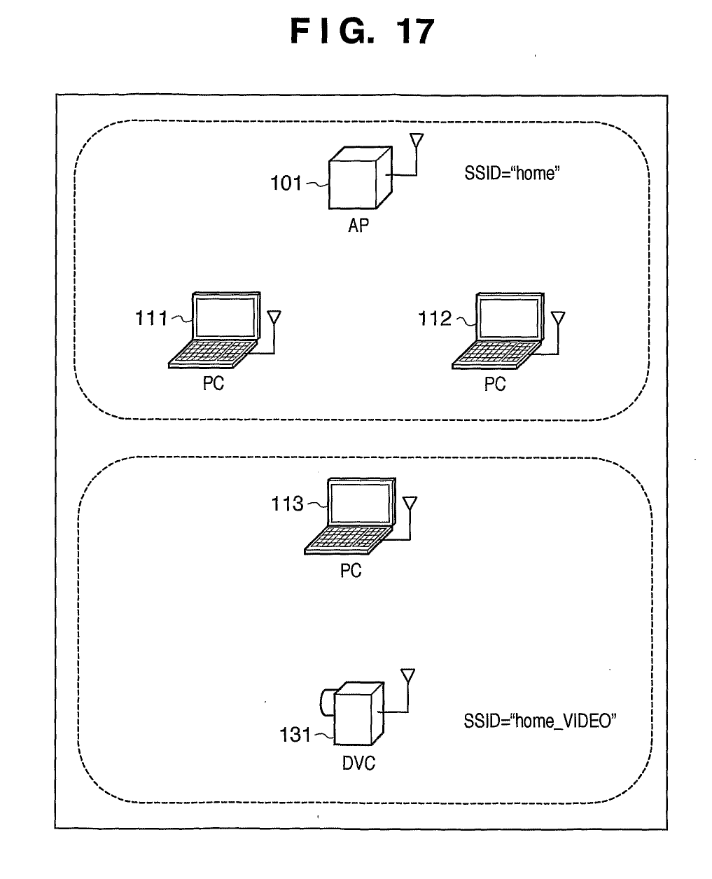

FIG. 17 shows a wireless network configuration after the above SSID setting. Here, the AP 101 controls the BSS “home”, having set the SSID to “home” in the AP function unit 201. The PCs 111 and 112 perform wireless communication within the BSS “home” controlled by the AP 101, having set the SSID to “home” in their respective STA function unit 211. The DVC 131 controls the BSS “home_VIDEO”, having set the SSID to “home_VIDEO” in the AP function unit 233. The PC 113 performs wireless communication within the BSS “home_VIDEO” controlled by the DVC 131, having set the SSID to “home_VIDEO” in the STA function unit 211. In particular, the DVC 131 and the PC 113 perform wireless communication related to the video server and video client, as wireless communication.

As described above, a character string that includes a common basic string is used as an SSID, according to the wireless communication system of the second embodiment. Further, the extension string is set based on an application run by the apparatus. Network connectivity can thereby be easily maintained even if a BSS is newly created or discarded. In other words, the usability of network connection can be improved.

### Third Embodiment

In a third embodiment, a method of setting the character string of an SSID based on a communication protocol related to a network to be newly created will be described.

<System Configuration>

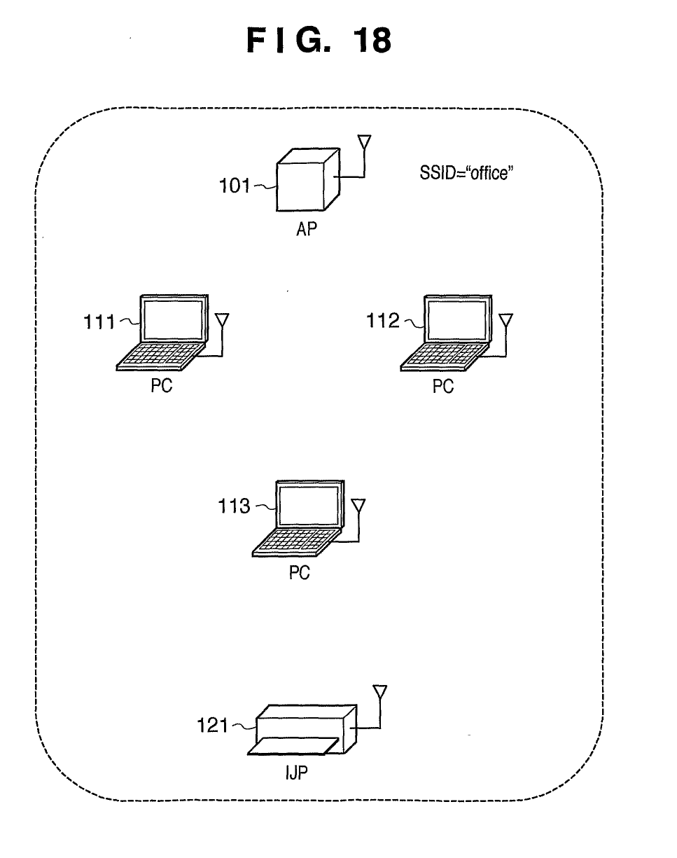

FIG. 18 illustratively shows a wireless network configuration in an initial state in a wireless communication system according to the third embodiment. Note that since the internal configurations of the various apparatuses are similar to the first embodiment, description thereof will be omitted.

The AP 101 controls a BSS in which “office” is set in the AP function unit 201 as the character string of the SSID. On the other hand, the PCs 111 to 113 and the IJP 121 perform wireless communication within the BSS “office” controlled by the AP 101, having set the same character string “office” as the AP 101 in their respective STA function unit 211 or 221 as the character string of the SSID.

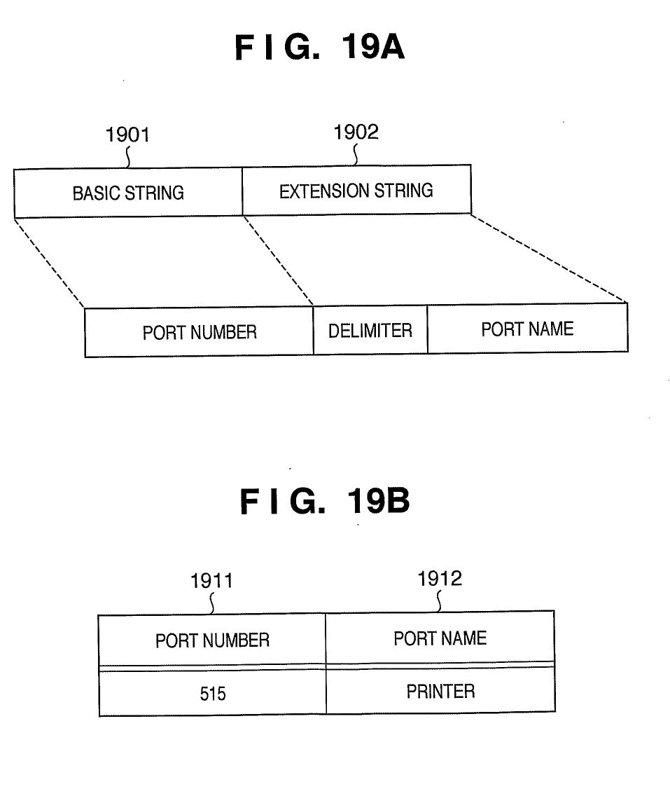

FIGS. 19A and 19B illustrate a setting format of the character string of the SSID to be used by a new BSS in the wireless communication system according to the third embodiment.

In FIG. 19A, reference numeral 1901 denotes a basic string. The basic string 1901 is set to a character string showing a port number for the primary communication protocol to be used. Reference numeral 1902 denotes an extension string. The extension string 1902 is set to a character string that combines the delimiter “_” and a port name. In other words, a character string that combines a port number, “_” and a port name is set as the character string of the SSID to be used by the new BSS.

FIG. 19B shows a setting table for designating a port name. Reference numeral 1911 denotes a port number for a communication protocol, with “515” being registered. Reference numeral 1912 denotes a port name corresponding to a port number, with “PRINTER” being registered here.

### Operation Example of Wireless Communication System

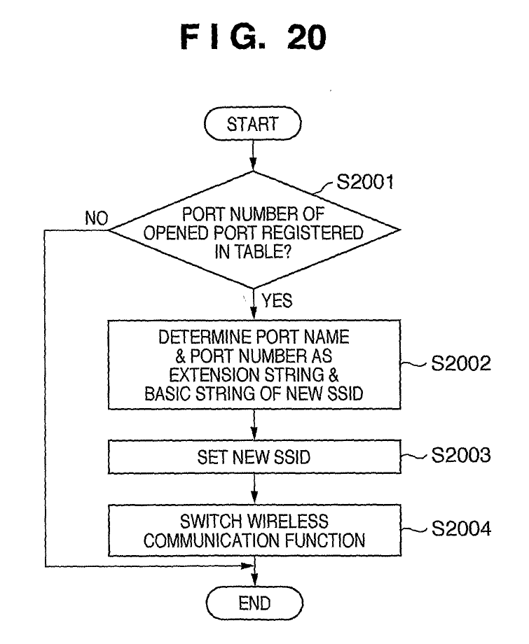

FIG. 20 is a flowchart showing an operation example of the wireless communication system. Here, it is assumed that a new network is created if a Transmission Control Protocol (TCP) or User Datagram Protocol (UDP) port for print data transmission is opened by the IJP 121. The following steps of the flowchart are executed by the control unit 225 of the IJP 121.

At step S2001, the control unit 225 determines whether the port number of the opened port is registered in the setting table shown in FIG. 19B. If registered, the processing proceeds to step S2002, and if not registered, the processing ends. For example, the control unit 225 determines whether “515” is registered.

At step S2002, the control unit 225 sets the extension string 1902 of the SSID to be newly set in the AP function unit 223 to the port name corresponding to the port number of the opened port. Here, the delimiter “_” and “PRINTER” are set as the extension string 1902. The control unit 225 also determines the port number as the basic string 1901 of the SSID to be newly set.

At step S2003, the control unit 225 determines a character string composed of a combination of the basic string 1901 and the extension string 1902 determined at step S2002 as the SSID to be newly set, and sets this character string in the AP function unit 223.

At step S2004, the control unit 225 controls the wireless communication function switching unit 222 to switch the wireless function from the STA function unit 221 to the AP function unit 223.

The IJP 121 creates a new BSS as a result of the above steps. Following on, an example in which the PC 113 sets an SSID will now be described.

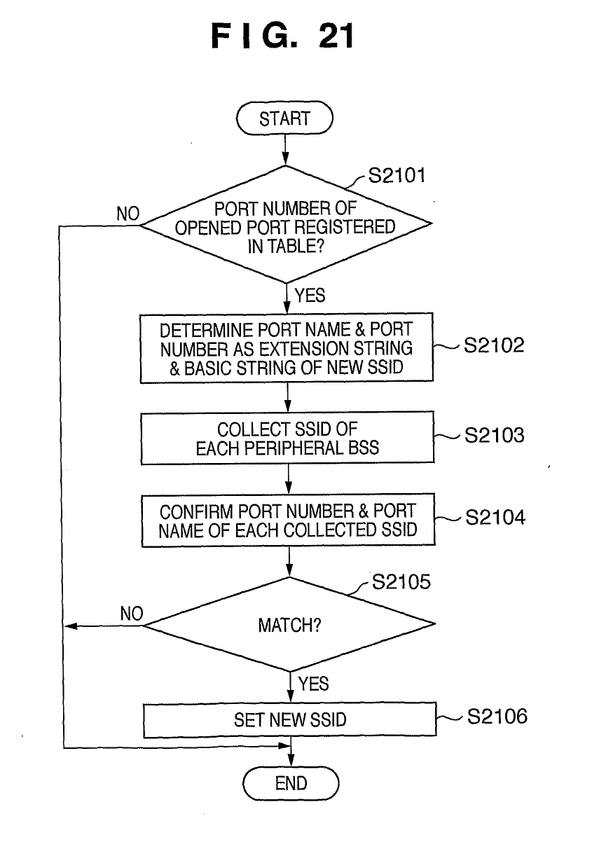

FIG. 21 is a flowchart showing a following operation example of the wireless communication system. Here, it is assumed that a port with the port number “515” has been opened by the PC 113. The following steps of the flowchart are executed by the control unit 213 of the PC 113.

At step S2101, the control unit 213 determines whether the port number of the opened port is registered in the setting table shown in FIG. 19B. If registered, the processing proceeds to step S2102, and if not registered, the processing ends. For example, the control unit 213 determines whether “515” is registered.

At step S2102, the control unit 213 sets the extension string 1902 of the SSID to be newly set in the STA function unit 211 to the port name corresponding to the port number of the opened port. Here, the delimiter “_” and “PRINTER” are set as the extension string 1902. The control unit 213 also determines the port number as the basic string 1901 of the SSID to be newly set.

At step S2103, the control unit 213 scans for and collects the SSIDs of BSSs created in the vicinity of the PC 113.

At step S2104, the control unit 213 confirms the basic string 1901 and the extension string 1902 of each SSID collected at step S2103.

At step S2105, the control unit 213 confirms whether there exists an SSID in which the basic string 1901 and the extension string 1902 match the character string determined at step S2102. For example, the control unit 213 confirms whether there exists an SSID that matches “515_PRINTER”. If a matching SSID does not exist, the processing ends.

At step S2106, the control unit 213 determines the character string confirmed to exist at step S2105 as the character string of the new SSID, and sets this character string in the STA function unit 211.

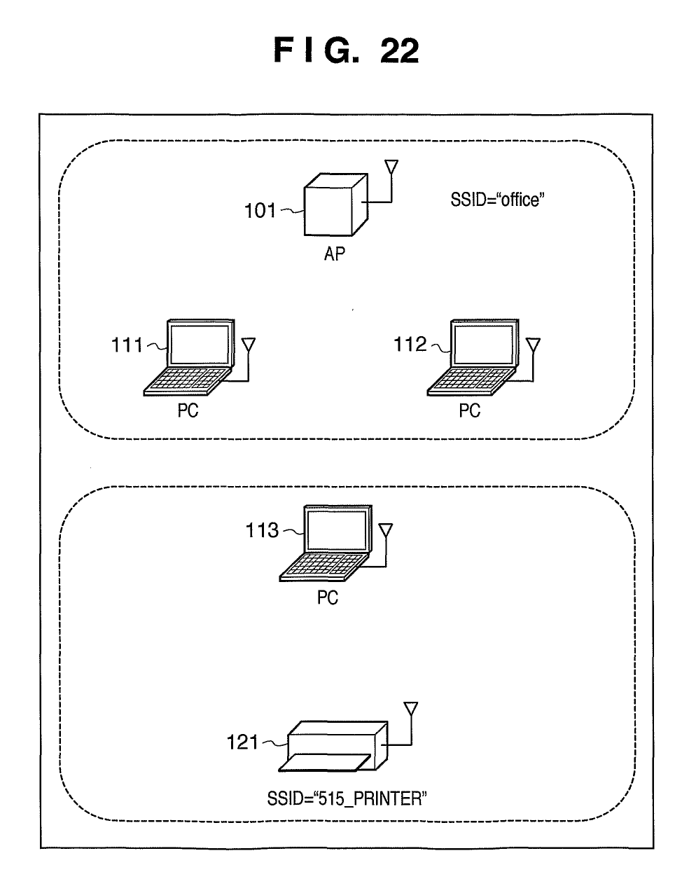

FIG. 22 shows the wireless network configuration after the above SSID setting. Here, the AP 101 controls the BSS “office”, having set the SSID to “office” in the AP function unit 201. The PCs 111 and 112 perform wireless communication within the BSS “office” controlled by the AP 101, having set the SSID to “office” in their respective STA function unit 211. The IJP 121 controls the BSS “515_PRINTER”, having set the SSID to “515_PRINTER” in the AP function unit 223. The PC 113 performs wireless communication within the BSS “515_PRINTER” controlled by the IJP 121, having set the SSID to “515_PRINTER” in the STA function unit 211. In particular, the IJP 121 and the PC 113 perform wireless communication related to printing, as wireless communication.

As described above, a port number and a port name related to a communication protocol are used as the character string of an SSID, according to the wireless communication system of the third embodiment. Network connectivity can thereby be easily maintained even if a BSS is newly created or discarded. In other words, the usability of network connection can be improved.

### Fourth Embodiment

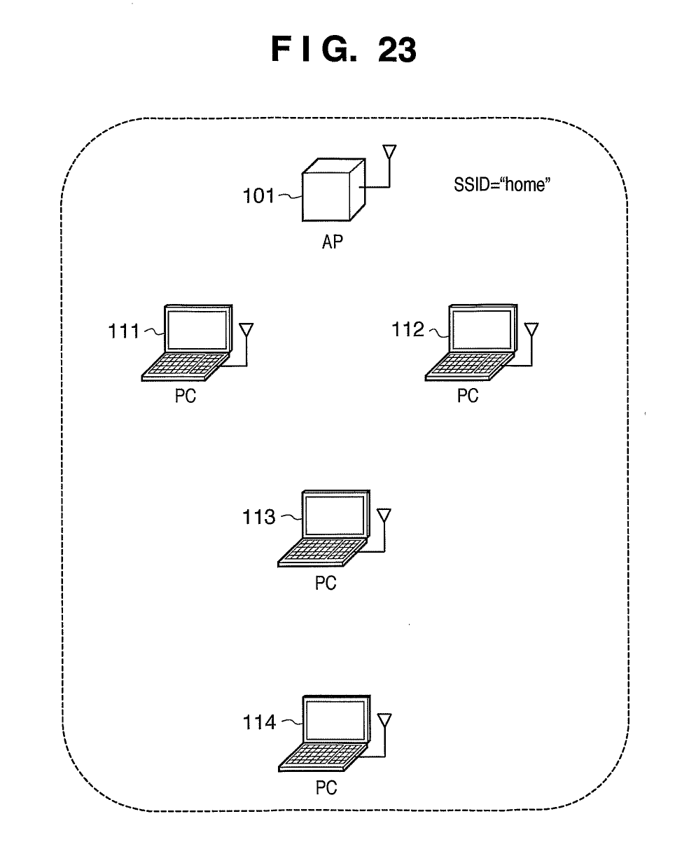

FIG. 23 illustratively shows a wireless network configuration in an initial state in a wireless communication system according to a fourth embodiment. Note that since the internal configurations of the various apparatuses are similar to the first embodiment, description thereof will be omitted.

The AP 101 controls a BSS in which “home” is set in the AP function unit 201 as the character string of the SSID. On the other hand, the PCs 111 to 114 perform wireless communication within the BSS “home” controlled by the AP 101, having set the same character string “home” as the AP 101 in their respective STA function unit 211 as the character string of the SSID.

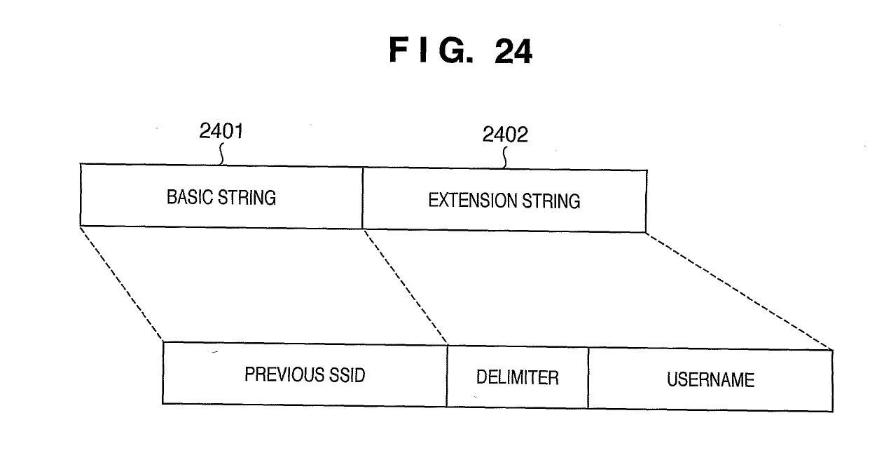

FIG. 24 shows a setting format of the character string of the SSID to be used by a new BSS in the wireless communication system according to the fourth embodiment.

In FIG. 24, reference numeral 2401 denotes a basic string. The basic string 2401 is set to the character string of the SSID previously used, which is the character string used in the initial state, for example. Reference numeral 2402 denotes an extension string. The extension string 2402 is set to a character string that combines the delimiter “_” and a username. In other words, a character string that combines the SSID previously used, “_” and a username is set as the character string of the SSID to be used by the new BSS.

### Operation Example of Wireless Communication System

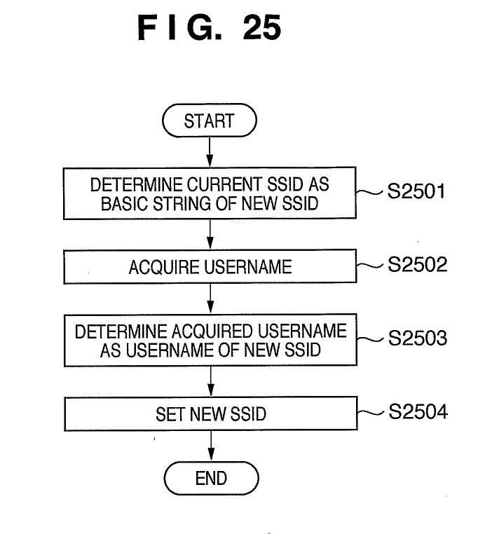

FIG. 25 is a flowchart showing an operation example of the wireless communication system. The process is started in the PC 113 or 114 when some sort of trigger occurs. The trigger may, for example, be the receipt of an instruction from a user to change BSSs in the PC 113 or 114. The following steps of the flowchart are executed by the control unit 213 of the PC 113.

At step S2501, the control unit 213 determines the character string of the SSID currently set in the STA function unit 211 as the basic string 2401 of the SSID to be newly set.

At step S2502, the control unit 213 acquires the username used when the instruction to change BSSs was received. For example, the username of the user logged in at that time is acquired.

At step S2503, the control unit 213 determines the username acquired at step S2502 as the username to be used for the extension string 2402. For example, “TARO” is set.

At step S2504, the control unit 213 determines a character string composed of a combination of the basic string 2401 determined at step S2501, the delimiter “_” and the username determined at step S2503 as the character string of the SSID to be newly set, and sets this character string in the STA function unit 211. For example, “home_TARO” is set as the character string of the SSID.

The PC 113 creates a new BSS as a result of the above steps. Subsequently, the other PC 114 connects to the PC 113 at an arbitrary timing. At this time, the PC 114 is able to confirm the existence of the BSS “home_TARO” by scanning for peripheral BSSs. It is also evident that this BSS was originally derived from the BSS “home” by an instruction from “TARO”.

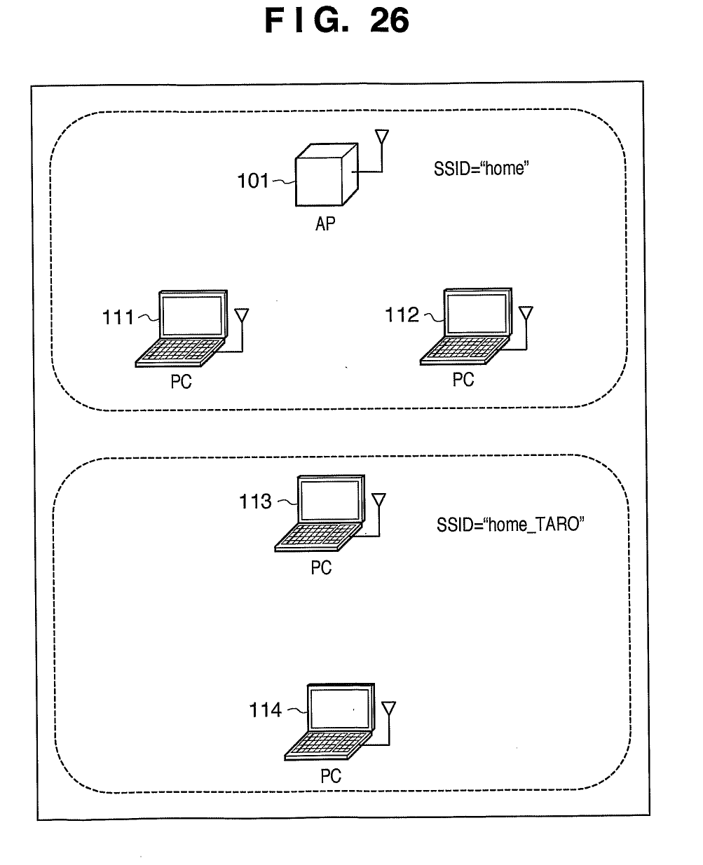

FIG. 26 shows the wireless network configuration after the above SSID setting. Here, the AP 101 controls the BSS “home”, having set the SSID to “home” in the AP function unit 201. The PCs 111 and 112 perform wireless communication within the BSS “home” controlled by the AP 101, having set the SSID to “home” in their respective STA function unit 211. The PC 113 controls the BSS “home_TARO”, having set the SSID to “home_TARO” in the STA function unit 211. The PC 114 performs wireless communication within the BSS “home_TARO” controlled by the PC 113, having set the SSID to “home_TARO” in the STA function unit 211.

As described above, a character string that includes a common basic string is used as an SSID, according to the wireless communication system of the fourth embodiment. Further, a username is used as the extension string. Network connectivity can thereby be easily maintained even if a BSS is newly created or discarded. In other words, the usability of network connection can be improved.

### Additional Embodiments

While embodiments have been detailed above, the present invention may be applied to a system constituted by a plurality of devices or an apparatus composed of a single device.

Note that the present invention is also achieved by a computer program that realizes the functions of the foregoing embodiments being directly or remotely supplied to a system or an apparatus, and the system or apparatus reading out and executing the supplied program code. Consequently, the technical scope of the present invention also encompasses the actual program code installed on a computer, in order to realize the functions and processes of the present invention by computer.

In this case, any mode of program, whether it be object code, a program executed by an interpreter or script data supplied to an operating system, is acceptable, as long as the functions of the program are provided.

Recording media for supplying the program include, for example, floppy® disk, hard disk, optical disk (CD, DVD), magneto-optical disk, magnetic tape, nonvolatile memory card, and ROM.

The functions of the forgoing embodiments can be realized by a computer executing the read program. For example, an OS or the like running on a computer can perform part or all of the actual processing based on instructions in the program, with the functions of the foregoing embodiments being realized by this processing.

Further, the program read out from the recording medium may be written to a memory provided in a function expansion board inserted in a computer or a function expansion unit connected to a computer. A CPU or the like provided in the function expansion board or the function expansion unit may subsequently perform part or all of the actual processing based on instructions in the program, with the functions of the foregoing embodiments being realized by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-035083, filed Feb. 15, 2008, which is hereby incorporated by reference herein in its entirety.

1. A communication apparatus comprising:
a communication unit configured to communicate based on a network identifier;
a setting unit configured to set the network identifier to communicate by said communication unit,
wherein said setting unit sets a first network identifier related to a second network identifier, if switching to a first network of the first network identifier from a second network of the second network identifier.

2. The communication apparatus according to claim 1, wherein a character string of the first network identifier includes a character string of the second network identifier.

3. The communication apparatus according to claim 1, wherein said setting unit sets the first network identifier to create a new network based on the second network identifier.

4. The communication apparatus according to claim 1, wherein said setting unit sets the first network identifier to create a new network, if switching to operating as a master station from operating as a slave station.

5. The communication apparatus according to claim 1, wherein said setting unit sets the first network identifier, if switching to the participated network as a slave station.

6. A communication apparatus that has a base station function for operating as a base station and a slave function for operating as a slave station which connects to a base station, comprising:
a switching unit configured to switch from operating as the slave station to operating as the base station; and
a setting unit configured to set, if switching to operating as the base station by the switching unit, a character string constituting an identifier of a new network,
wherein the setting unit sets the character string constituting the identifier of the new network, so as to include a character string constituting an identifier of a network participated in when operating as the slave station.

7. The communication apparatus according to claim 6, wherein the setting unit sets a character string obtained by adding an extension string to the character string constituting the identifier of the network participated in when operating as the slave station, as the character string constituting the identifier of the new network, in order to relate the new network to the network participated in when operating as the slave station, and
wherein the extension string includes a delimiter string indicating a branching hierarchy from the network participated in as the slave station, and an identifier string for distinguishing from another network that exists in the same branching hierarchy.

8. The communication apparatus according to claim 6, further comprising a search unit configured to search for an identifier of a peripheral network,
wherein the setting unit adds information for distinguishing from an identifier retrieved by the search unit to the character string constituting the identifier of the network participated in when operating as the slave station.

9. The communication apparatus according to claim 6, wherein the setting unit adds information relating to an application to be used by the newly created network to the character string constituting the identifier of the network participated in when operating as the slave station.

10. The communication apparatus according to claim 9, wherein the information relates to a protocol to be used by the application.

11. A communication apparatus having a slave function for connecting to a base station, comprising:
a setting unit configured to set a character string constituting an identifier of a network to be connected by the slave function;
a determination unit configured to determine whether there exists a base station that has created a network whose identifier is constituted by a same character string as the character string constituting the identifier set by the setting unit;
a search unit configured to search for an identifier of a peripheral network, if determined by the determination unit that the base station does not exist; and
a control unit configured to control the setting unit to set, as a changed character string, a character string, out of character strings constituting one or more identifiers retrieved by the search unit, at least part of which matches the character string constituting the identifier currently set by the setting unit.

12. The communication apparatus according to claim 11, further comprising:
a display unit configured to hierarchically display the character strings constituting the one or more retrieved identifiers as a list based on similarity with the character string constituting the identifier currently set by the setting unit; and
a reception unit configured to receive from a user a selection designation of one of the one or more character strings displayed as a list by the display unit,
wherein the control unit sets the character string received by the reception unit as the changed character string.

13. (canceled)

14. A control method of a communication apparatus comprising:
a communication step of communicating based on a network identifier;
a setting step of setting the network identifier to communicate at said communication step,
wherein said setting step sets a first network identifier related to a second network identifier, if switching to a first network of the first network identifier from a second network of the second network identifier.

15. A control method of a communication apparatus that has a base station function for operating as a base station and a slave function for operating as a slave station which connects to a base station, comprising:
a switching step of switching from operating as the slave station to operating as the base station; and
a setting step of setting, if switching to operating as the base station in the switching step, a character string constituting an identifier of a new network, wherein
in the setting step, the character string constituting the identifier of the new network is set so as to include a character string constituting an identifier of a network participated in when operating as the slave station.

16. A control method of a communication apparatus that has a slave function for connecting to a base station, comprising:
a setting step of setting a character string constituting an identifier of a network to be connected by the slave function;
a determination step of determining whether there exists a base station that has created a network whose identifier is constituted by a same character string as the character string constituting the identifier set in the setting step;
a search step of searching for an identifier of a peripheral network, if determined in the determination step that the base station does not exist; and
a control step of setting, as a changed character string, a character string, out of character strings constituting one or more identifiers retrieved in the search step, at least part of which matches the character string constituting the identifier currently set in the setting step.
